(19) United States
(12) Patent Application Publication
(10) Pub. No.: US 2026/0071657 A1
(43) Pub. Date: Mar. 12, 2026

(54) INTEGRATED PARKING BRAKE STRUCTURE

(71) Applicant: Divergent Technologies, Inc., Los Angeles, CA (US)

(72) Inventors: Marco PAGNI, Los Angeles, CA (US); Samir Antonio VALLEJO NEVAREZ, Torrance, CA (US)

(73) Assignee: Divergent Technologies, Inc., Los Angeles, CA (US)

(21) Appl. No.: 19/324,991

(22) Filed: Sep. 10, 2025

Related U.S. Application Data
(60) Provisional application No. 63/693,597, filed on Sep. 11, 2024.

(51) Int. Cl. F16D 55/227; B60T 13/74; F16D 55/00; F16D 65/00; F16D 65/095; F16D 121/24

(52) U.S. Cl. CPC F16D 55/227; B60T 13/746; F16D 65/0056; F16D 65/095; B60T 2270/402; F16D 2055/0008; F16D 2121/24; F16D 2250/00

(57) ABSTRACT

An apparatus including an upright and a parking brake mounted within an integral portion the upright. The parking brake includes one or more parking brake pads mounted to the integral portion of the upright and the one or more parking brake pads are configured to apply a braking force on a rotor of a vehicle. The one or more parking brake pads are mounted on studs and the studs receive forces from the application of the one or more parking brake pads to the rotor and transfer these forces to the upright. The upright is configured to be coupled to a wheel of the vehicle and also includes a second portion configured to integrate a main caliper configured to apply a braking force on the rotor of the vehicle.

### CROSS REFERENCE TO RELATED APPLICATIONS

This application claims the benefit of U.S. Provisional Application No. 63/693,597 filed on Sep. 11, 2024 entitled “ELECTROMECHANICAL PARKING BRAKE”, wherein the provisional application is expressly incorporated by reference herein in its entirety.

### BACKGROUND

### Technical Field

The present disclosure relates generally to an apparatus enabling vehicle braking, and more specifically to a parking brake integrated into the apparatus to prevent a vehicle from rolling when the vehicle is parked and capable of decelerating and stopping the vehicle.

### Description of the Related Technology

Vehicles such as trucks and cars have braking systems to reduce the vehicles speed, to stop the vehicle and to prevent the vehicle from rolling when the vehicle is parked. The braking systems may include a parking brake system and a main braking system. The parking braking system functions to prevent the vehicle from rolling when the vehicle is parked and the main braking system functions to reduce the vehicles speed and to stop the vehicle. A braking system may include various components such as rotors and brake pads, and may include an associated brake caliper to which the brake pads are attached and applies the brake pads to the rotor with such force that friction slows and can stop the rotor and the wheel attached to the rotor or can prevent the vehicle from rolling when the vehicle is parked. Vehicles also have suspension systems. A suspension system may include an upright that attaches to the wheel and allows the wheel to rotate. Various other suspension components may be attached to the upright, such as control arms and other linkages, to allow the upright to turn the wheel and move with the up and down motion of the wheel when driving over bumps and potholes, for example.

In conventional braking systems, the brake pads are attached to the brake caliper for example, a housing of the brake caliper. Therefore, the housing/caliper will experience braking forces and torque applied thereto when the brake pads are applied to the rotor which may lead to reliability and failure problems due to the housing/caliper experiencing unexpected large forces and torque. In order to support design expected braking forces and torque, the brake caliper and/or housing of the brake caliper will need to be designed in a manner that will support these expected braking forces and torque and this may add extra mass, complexity and costs to the brake caliper, housing and the braking and suspension systems.

### SUMMARY

In this disclosure, it is recognized that a parking brake of a vehicle can be integrated into an upright such that the parking brakes'one or more parking brake pads can be mounted to a portion of the upright. In various embodiments, numerous advantages may be realized as described in more detail below for the various embodiments. For example, benefits of fewer parts, no tooling, compactness, optimizable for each application, efficient wiring configuration, increased strength, stiffness and rigidity, less mass, centralization of mass, increased robustness and reliability, tunable noise, vibration and harshness (NVH) performance, fast assembly, etc. may be realized within the disclosed below various embodiments.

In various embodiments disclosed herein is an apparatus enabling vehicle braking. In one embodiment, the apparatus includes one or more parking brake pads mounted to an upright such that the one or more parking brake pads are configured to apply a braking force to a vehicles rotor in order to prevent the vehicle from rolling when the vehicle is parked, even when parked on an incline/graded slope of (i.e., up/down to) about thirty percent, and the braking force is capable of decelerating the vehicles speed and even stopping the vehicles motion. The upright is configured to be coupled to a wheel of a vehicle and includes an integral portion to which the one or more parking brake pads are mounted. The integral portion of the upright means the integral portion and the upright are a one piece/single structure. A parking brake may be integrated into the integral portion (e.g., an integral first portion) of the upright and includes the one or more parking brake pads. Also, the parking brake may be an independent (e.g., a separate/redundant) apparatus/mechanism from a vehicles main braking system. For example, if the main braking system fails to perform its function of decelerating and/or stopping the vehicle, the parking brake may be activated to decelerate the vehicles speed and stop the vehicles motion.

Additionally, in one or more embodiments, the upright may include a second portion configured to integrate a main caliper configured to apply a brake force on the rotor of the vehicle. The upright may be a three-dimensionally (3D) printed structure and 3D printed by a powder bed fusion (PBF) printer or another additively manufacture apparatus/method or any other type of manufacturing method. The upright may be made from a metal. For example, the upright may include an alloy such as an aluminum alloy.

In one or more embodiments, the integral first portion may include a recessed region configured to contain the parking brake.

In one or more embodiments, the second portion may be integral with the upright. For example, the second portion and the upright are a one piece/single structure.

In one or more embodiments, the upright may be an integral (i.e., a one piece/single) structure. The integral structure upright may be formed by powder bed fusion.

Additionally, in one or more embodiments, the parking brake may include a housing. The housing may be a 3D printed structure and 3D printed by a PBF printer or another additively manufacture apparatus/method or any other type of manufacturing method. The housing may be made from a metal. For example, the housing may include an alloy such as an aluminum alloy.

In one or more embodiments, the housing may be coupled to the integral first portion.

In one or more embodiments, the housing may be configured in the apparatus such that it is not subjected to a torque generated by at least the one or more parking brake pads applied against the rotor.

Additionally, in one or more embodiments, the housing may include a region comprising a hollow portion. In one or more embodiments, the region may be configured to receive a force generated by at least the one or more parking brake pads applied against the rotor.

Additionally, in one or more embodiments, the parking brake may include a cover coupled to the housing. The cover may be a 3D printed structure and 3D printed by a PBF printer or another additively manufacture apparatus/method or any other type of manufacturing method. The cover may be made from a metal. For example, the cover may include an alloy such as an aluminum alloy.

In one or more embodiments, the cover may include a first opening and the housing may include a second opening such that a device is configured to extend through the first and second openings and cause the one or more parking brake pads to be applied to the rotor.

In one or more embodiments, the one or more parking brake pads may include a first parking brake pad and a second parking brake pad and the parking brake may include a structure configured to force the first parking brake pad and the second parking brake pad against the rotor.

In one or more embodiments, the structure may be coupled to the cover. The structure may include an actuator.

In one or more embodiments, the actuator may be configured to be electrically activated.

Additionally, in one or more embodiments, the apparatus may include a joining device coupled to the integral first portion and to at least the first parking brake pad or the second parking brake pad. The braking force generated by at least the first parking brake pad or the second parking brake pad contacting the rotor may be transmitted to the upright and/or the joining device. In one or more embodiments, the braking force may be transmitted to the joining device and the joining device transmits the braking force to the upright. The braking force may include a torque.

In one or more embodiments, the one or more parking brake pads may include a first parking brake pad and a second parking brake pad. The first parking brake pad may be mounted on a first feature of the integral first portion and the second parking brake pad may be mounted on a second feature of the integral first portion.

In one or more embodiments, the first feature may include a first structure and a second structure.

In one or more embodiments, the first structure and/or the second structure may be integral with the integral first portion.

In one or more embodiments, the second feature may include a third structure and a fourth structure.

In one or more embodiments, the third structure and/or the fourth structure may be integral with the integral first portion.

Additionally, in one or more embodiments, the first structure may include a first stud coupled to the first structure and the second structure.

Additionally, in one or more embodiments, the second structure may include a second stud coupled to the third structure and the fourth structure.

Additionally, in one or more embodiments, the apparatus may include a joining device coupled to the first feature and the second feature and connecting the first parking brake pad and the second parking brake pad to the integral first portion.

In one or more embodiments, the first feature may include a first aperture and a second aperture and the second feature may include a third aperture and a fourth aperture.

In one or more embodiments, the joining device may include a plurality of connectors.

It will be understood that other aspects of the apparatus will become readily apparent to those skilled in the art from the following detailed description, wherein it is shown and described only several embodiments by way of illustration. As will be realized by those skilled in the art, the apparatus and its structures/components are capable of other and different embodiments, and its several details are capable of modification in various other respects, all without departing from the invention. For instance, features (e.g., housing, cover, actuator, upright, studs, fasteners, connectors, parking brake pads, parking brake, etc.) illustrated or described as part of one embodiment can be used in/with another embodiment to yield a still further embodiment. Thus, it is intended that the present disclosure covers such modifications and variations as come within the scope of the appended claims and their equivalents. Accordingly, the drawings and detailed description are to be regarded as illustrative in nature and not as restrictive.

### BRIEF DESCRIPTION OF THE DRAWINGS

Various aspects of the disclosure will now be presented in the detailed description by way of example, and not by way of limitation, in the accompanying drawings, wherein:

FIG. 1 illustrates a vehicle parking brake system in accordance with an aspect of the present disclosure.

FIG. 2 illustrates an exploded view of a parking brake integrated into an upright in accordance with an aspect of the present disclosure.

FIG. 3 illustrates an assembled perspective view of a parking brake integrated into an upright in accordance with an aspect of the present disclosure.

FIG. 4 illustrates another assembled perspective view of a main caliper and a parking brake integrated into an upright in accordance with an aspect of the present disclosure.

FIG. 5 illustrates a main caliper pad and a parking brake pad integrated into an upright in accordance with an aspect of the present disclosure.

FIG. 6 illustrates an perspective view of a vehicle rotor along with a main caliper and a parking brake integrated into an upright in accordance with an aspect of the present disclosure.

FIG. 7 illustrates an perspective view of a parking brake integrated into an upright in relation to parts of a vehicle in accordance with an aspect of the present disclosure.

FIG. 8 illustrates a partial cross-sectional view of a parking brake integrated into an upright in relation to parts of a vehicle in accordance with an aspect of the present disclosure.

FIG. 9 illustrates a detailed view of a parking brake in accordance with an aspect of the present disclosure.

FIG. 10 illustrates a detailed view of a parking brake including connectors in accordance with an aspect of the present disclosure.

FIG. 11 illustrates a detailed view of a cover in accordance with an aspect of the present disclosure.

FIG. 12 illustrates a detailed cross-sectional view of an actuator and a parking brake housing with an aspect of the present disclosure.

FIG. 13 illustrates a detailed perspective cross-sectional view of coupling of a cover to a parking brake housing integrated into an upright and parking brake pads applied to a rotor of a vehicle by components of an actuator with an aspect of the present disclosure.

FIG. 14 illustrates a detailed perspective view of an actuator and its components with an aspect of the present disclosure.

### DETAILED DESCRIPTION

As stated above, conventional braking systems generally have their brake pads attached to the brake caliper or housing of the brake caliper and thus, the brake caliper/housing design may not be an optimal design nor economically or functionally efficient due to at least the factors and problems stated above. To overcome the above problems and inefficiencies, there is a need to develop a parking brake, which does not experience some of the forces generated by parking brake pads applied to a rotor of a vehicle. More specifically, the disclosure has accomplished overcoming the above problems and inefficiencies by at least having one or more parking brake pads mounted on studs of an upright and having the force(s), which are generated by the one or more parking brake pads applied to one or more surfaces of a rotor of a vehicle, applied to the upright. In solving these problems and inefficiencies, the parking brake and other vehicle systems and structures may be reduced in size, mass and complexity and in addition, may have a longer useful life and may be more reliable in performing their function(s).

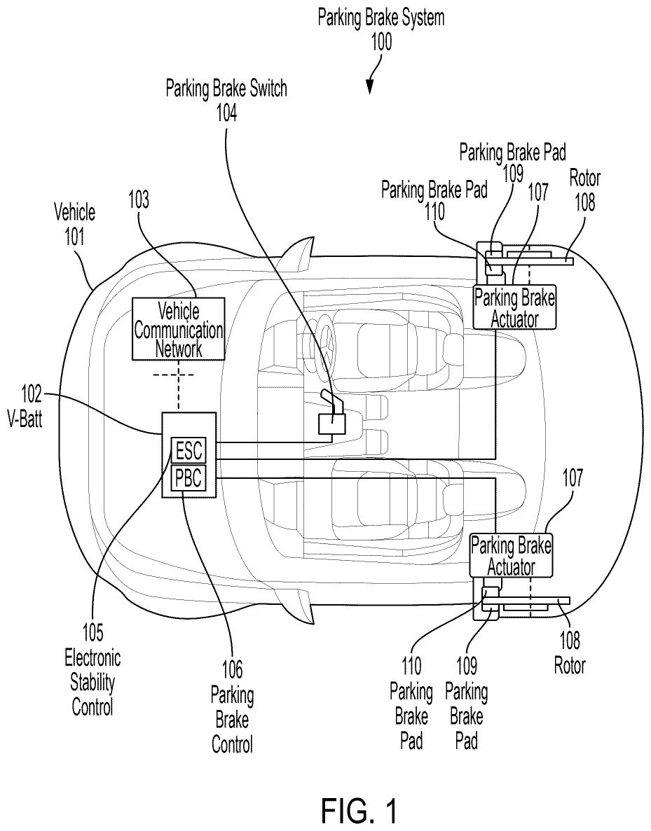

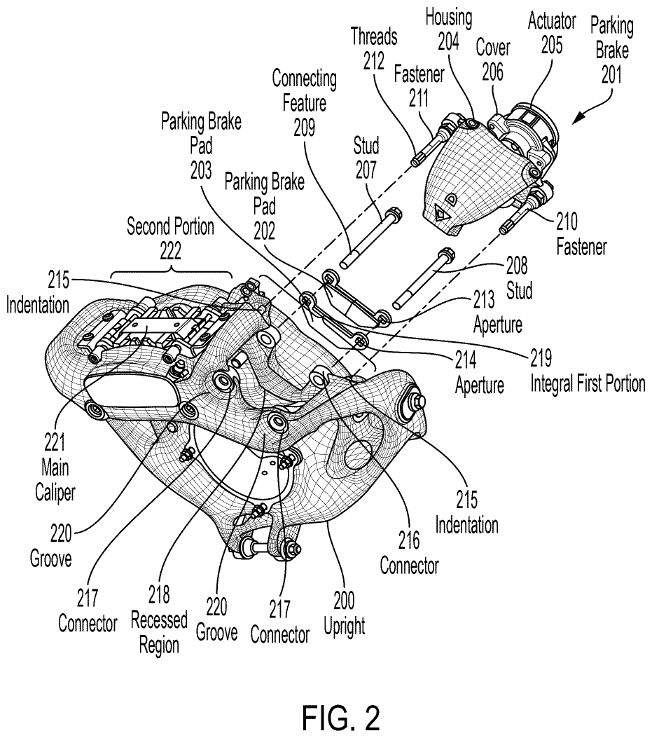

FIG. 1 illustrates a parking brake system 100 in a vehicle 101 incorporating an apparatus which includes an upright (e.g., 200, see FIG. 2) and a parking brake (e.g., 201, see FIG. 2). The apparatus, the upright and the parking brake will be described in detail within the below disclosure. In addition to the apparatus, the parking brake system may include a battery 102, a vehicle communication network 103 and a parking brake switch 104. As will be shown in more detail below, the parking brake in the parking brake system may include one or more parking brake pads 109,110 and an actuator 107. The vehicle communication network 103 may include electronic stability control (ESC) 105 and parking brake control (PBC) 106. Each of the electronic stability control and the parking brake control may include a unit/module, which may be hardware and/or software. The hardware may include one or more processors, electronic circuits, a printed circuit board and other electronic and electromechancial devices. The software may include code and/or algorithms. The one or more processors may be configured to execute the code and/or algorithms. The parking brake switch functions to send a signal to a vehicle's electronic control unit (ECU) such as the PBC to activate the actuator, which is configured to apply and release the parking brake's one or more parking brake pads respectively, to and from the rotor, securing the vehicle from rolling or allowing the vehicle to move, respectively. The parking brake switch may be a button or a lever or other activation device. The ESC functions to prevent loss of vehicle control. For example, the ESC may receive data from various devices such as sensors and communicate with the actuator to apply braking via the one or more parking brake pads to individual wheels of the vehicle to prevent the vehicle from, for example, skidding or heading off its course. The PBC functions to provide power and control to the actuator in order to apply and release the parking brake. For example, the PBC activates the parking brake actuator to apply the one or more parking brake pads to the rotor to hold the vehicle stationary or provide braking such as emergency braking, and may provide automatic hill-start assist and brake pad wear control. Now that parts of the parking brake system have been disclosed, an example of the operation of the parking brake system is provided. If the vehicle is parked and one wants to utilize the parking brake system to prevent the vehicle from rolling while parked, the battery provides powder for a person to activate (e.g., push a button or pull/push a lever) the parking brake switch. Once the parking brake switch is activated, the actuator causes the one or more parking brake pads to be applied to the rotor creating a force that prevents the parked car from rolling, even when the vehicle is located on hilly terrain. The parking brake system including the apparatus may be used in various vehicles such as cars, trucks, vans, sport utility vehicles (SUV's), all-terrain vehicles (ATV's), motorcycles, etc. The vehicles may include a rotor 108 configured to rotate, may be coupled to a wheel of the vehicle and provides a surface(s) to which the one or more parking brake pads are applied. FIG. 1 explicitly illustrates two rear rotors but the vehicle in FIG. 1 also includes two front rotors and thus the vehicle includes four rotors and the below disclosed apparatus is associated with each rotor. However, the vehicle may include more or less rotors and apparatus. For example, if the vehicle has three wheels, then the parking brake system may include three rotors and three apparatuses.

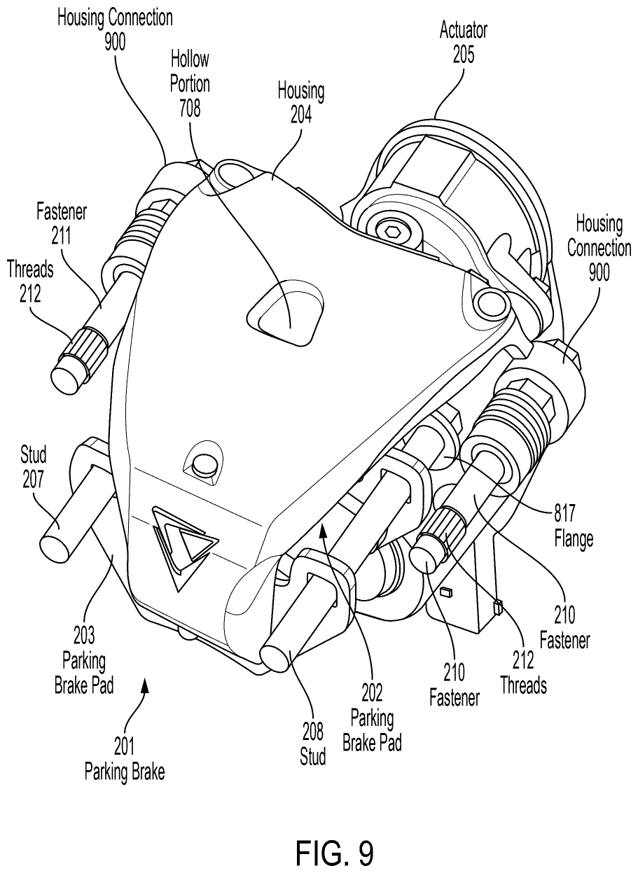

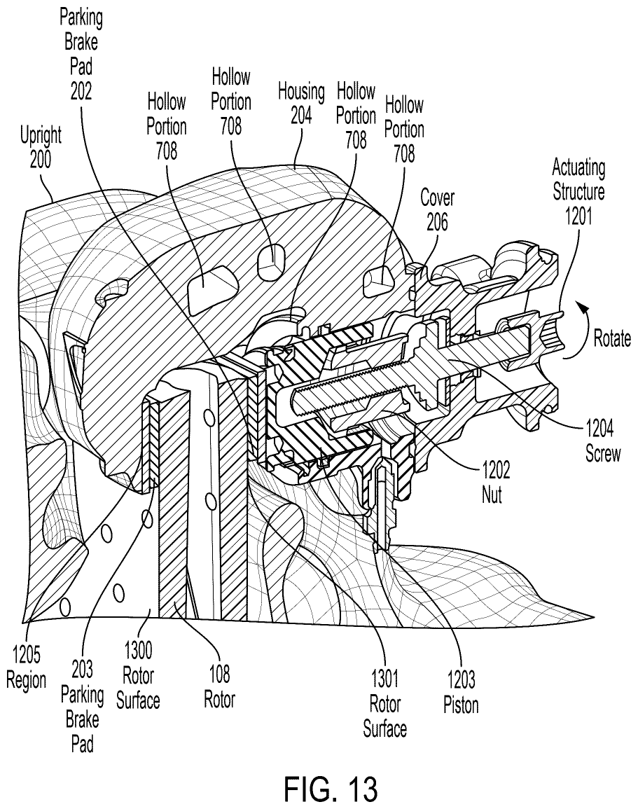

FIG. 2 illustrates an exploded view of a parking brake 201 integrated into an upright 200. The parking brake may include a housing 204 and parking brake pads 202,203 configured to apply a brake force on a rotor of a vehicle and mounted on studs 207,208 configured to be coupled to the upright via connectors 216,217 within grooves 220 of the upright. Additionally, the parking brake may include a cover 206 coupled to the housing and an actuator 205 coupled to the cover. The upright, the housing and the cover may be made from metal such as an aluminum alloy. Each stud may include a connecting feature 209 configured to be coupled to a corresponding connector 217. For example, the connecting feature may include threads which may inserted/screwed into internal grooves of a corresponding connector. Also, each stud may be configured to be removed (i.e., is removable) from the upright. The connectors may be rigid structures and may be formed of polymers, metals or composites. Fasteners 210,211 are configured to couple the housing via housing connection (e.g., 900, see FIG. 9) to the upright by being coupled to indentations 215 with the upright. For example, the fasteners may pass through corresponding holes of the housing connection within the housing and may have threads 212 (e.g., protrusions) which are inserted into corresponding mating portions such as corresponding grooved portions and/or friction fit portions within the indentations of the upright. Threads 212 may be formed on the fasteners or may be threads on an element and the element may be installed on each fastener. The threads may be formed in a straight line or may be curved. The element may include rubber or an elastic material or another material configured to at least provide a coupling such as a friction fit to the indentations of the upright. As will be explained in more detail in reference to FIG. 13, the housing is configured to slid/move along the length of the fasteners when the actuator is enabled (e.g., when the vehicle is parked) such that a piston (1203, see FIG. 13) moves toward the rotor and forces parking brake pad 202 against the rotor surface (1301, see FIG. 13) and a region (1205, See FIG. 13) of the housing is moved toward the rotor surface (1300, see FIG. 13) in order to apply a braking force against the rotor, preventing the vehicle from rolling while parked. Each of the parking brake pads 202,203 may have a plurality of apertures 213,214 such that the parking brake pads may be mounted on the studs. For example, parking bake pad 202 includes two apertures 213 such that stud 207 may fit within (i.e., extend through) one of the apertures and stud 208 may fit within (i.e., extend through) the other aperture. FIG. 2 illustrates each parking brake pad includes two apertures but more or less apertures may be included in each parking brake pad. Also, FIG. 2 illustrates two parking brake pads but more or less parking brake pads may be included as part of the parking brake. The upright illustrated in FIG. 2 includes an integral first portion 219 configured to contain/house the parking brake configured to apply a brake force on the rotor of the vehicle and a second portion 222 configured to contain/house a main caliper 221 configured to apply a brake force on the rotor of the vehicle. The integral first portion 219 includes a recessed region 218 with the upright such that the parking brake may be at least partially contained with this recessed region. The integral first portion 219 is formed integrally with the upright such that the upright and the integral first portion are/form a one piece/single structure.

In various embodiments, the connectors may be integrally formed with the upright such that the connectors may be part of the upright design and integrally form a portion of the upright. For example, connectors 216 may include two apertures within the upright for the corresponding studs to be placed/inserted therein and connectors 217 may include two threaded apertures within the upright for the studs'connection feature such as threads to be threaded into the corresponding threaded apertures. The integrally formed upright and connectors (i.e., the upright and connectors are a one/single piece structure) may be printed as a single (i.e., integral) piece in a 3D printer such as a powder bed fusion printer.

In various embodiments, the studs may be integrally formed (i.e., the studs and the upright form a single/one piece structure) with the upright and the parking brake pads may have one or more apertures or other features which allow the parking brake pads to be mounted to the integrally formed studs. For example, the parking brake pads may have a feature that mounts the parking brake pads to the integral studs and the feature may form an opening to allow the stud to pass therethrough and then the feature may close the opening to secure the stud therein such as a feature on a hiking clip allowing a rope to be inserted into the clip. A joining device may include any of the disclosed studs and connectors.

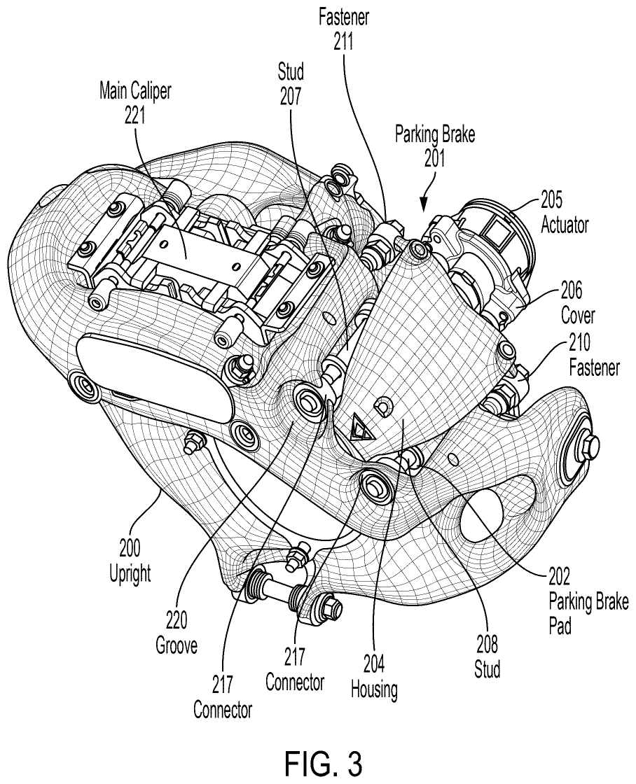

FIG. 3 illustrates an assembled perspective view of parking brake 201 integrated into upright 200. The parking brake may include cover 206 coupled to the housing and actuator 205 coupled to the cover. As shown in FIG. 3, the upright has main caliper 221 and parking brake 201 installed therein. Fasteners 210,211 are inserted into the corresponding indentations to couple the parking brakes'housing 204 to the upright. FIG. 3 also illustrates parking brake pad 202 mounted on stud 208 and the stud connected to connector 217 positioned with groove 220 of the upright.

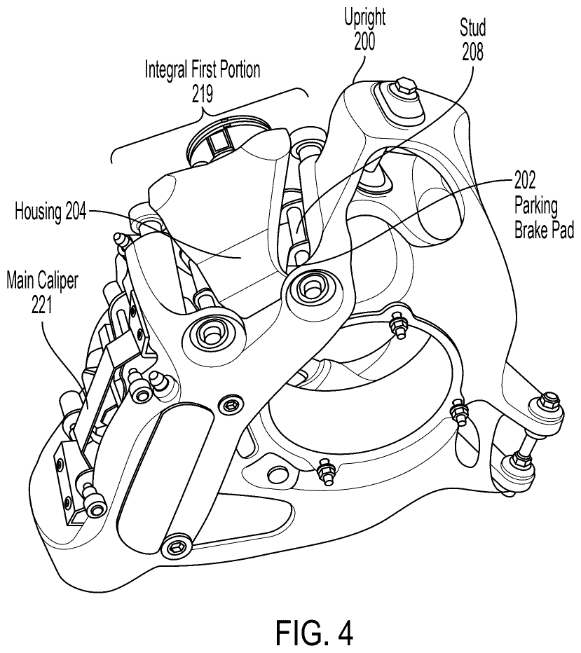

FIG. 4 illustrates another assembled perspective view showing the parking brakes'housing 204 integrated into upright 200 and parking brake pad 202 mounted on stud 208. FIG. 4 also illustrates main caliper 221 installed within the upright and first integral portion 219 of the upright containing the housing.

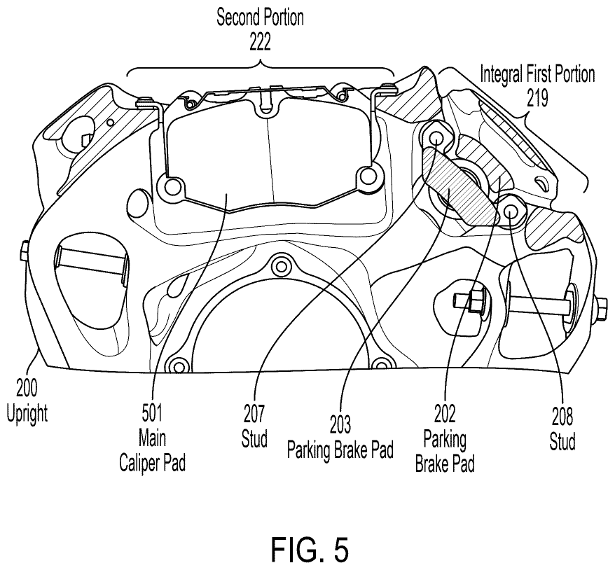

FIG. 5 illustrates the uprights'second portion 222 containing a main caliper pad 501 of the main caliper and the uprights'first integral portion 219 containing parking brake pads 202,203 mounted on studs 207,208. Because FIG. 5 does not provide a view that illustrates both sides of the upright, a second main caliper pad may be provided in the second portion on a opposite side of the rotor than main caliper pad 501.

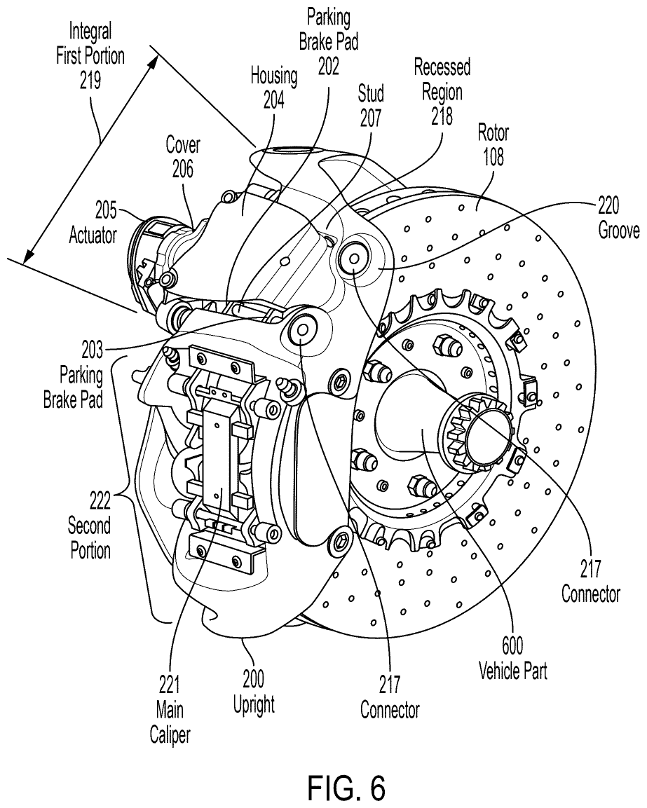

FIG. 6 illustrates an perspective view of upright 200 located relative to vehicle rotor 108. The upright has its first integrated portion 219 including recessed region 218 and its second portion 222 astride the rotor. FIG. 6 illustrates main caliper 221 within the second portion and parking brake housing 204 within the first integrated portion and positioned across each side of the rotor such the each of the parking brake pads 202,203 mounted on the studs 207,208 are configured to be applied to different surfaces of the rotor. For example, parking brake pad 203 is configured to contact the surface of the rotor that is on the side vehicle part 600 is shown extending from and parking brake pad 202 is configured to contact the back surface (i.e., opposed surface) of the rotor. Vehicle part 600 may include a wheel hub, and/or a drive shaft. FIG. 6 illustrates a side of each connector 217 including a flat portion flush again a surface within groove 220 of the upright.

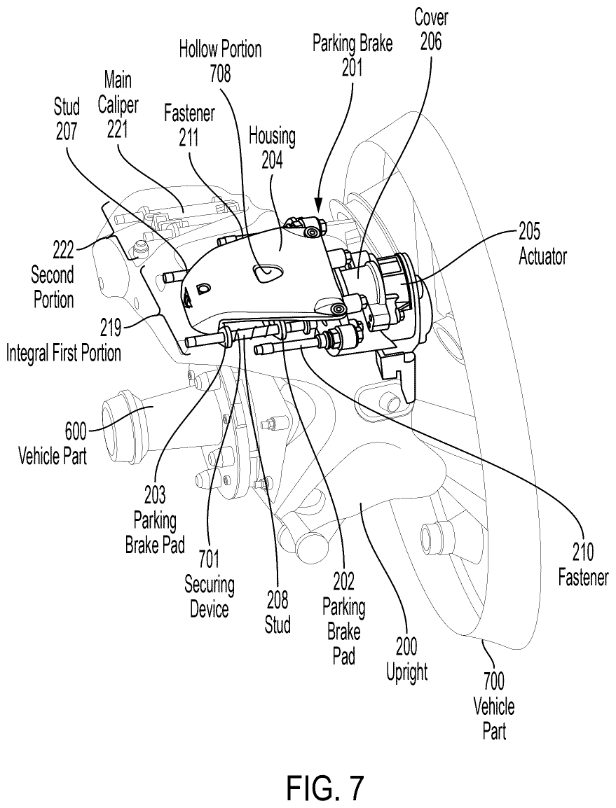

FIG. 7 illustrates an perspective view of parking brake 201 integrated into upright 200 in relation to parts 600,700 of a vehicle. Vehicle part 700 may include a wheel and/or a vehicle frame and/or a vehicle skin. The upright has parking brake 201 integrated into first integrated portion 219. The second portion 222 includes main caliper 221. The housing 204 of the parking brake includes a hollow portion 708 and has cover 206 coupled to the housing and actuator 205 is coupled to the cover. The hollow portion is configured to sustain stresses and stress concentrations. FIG. 7 illustrates the parking brake pads 202,203 mounted on studs 207,208 and fasteners 201,211 in relation to the housing. For example, the studs are positioned below the housing and spaced from a center line passing through the hollow portion of the housing. Each stud may be positioned adjacent to an inner edge or an outer edge of the housing.

Optionally, a securing device 701 for the one or more parking brake pads may be position on and/or around each of the studs. For example, a securing device may be one or more devices on or partially wraps around each stud and has ends secured/attached to corresponding apertures of the parking brake pads to prevent the parking brake pads from moving to an undesired location/position and to lessen and/or prevent the parking brake pads from vibrating on the studs due to the studs and the parking brake pads receiving loads and forces such as vehicle acceleration, vehicle braking and other forces applied to the studs and the parking brake pads. The securing device may include a spring or other flexible or elastic attachment/securing devices that are capable of attaching/coupling to the parking brake pads and studs to prevent unwanted movement of the parking brake pads and to lessen and/or prevent the parking brake pads from vibrating on the studs.

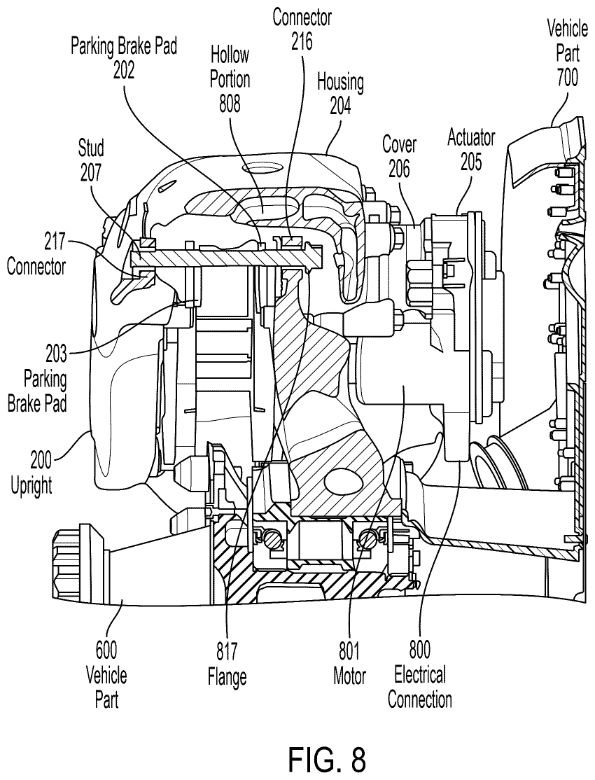

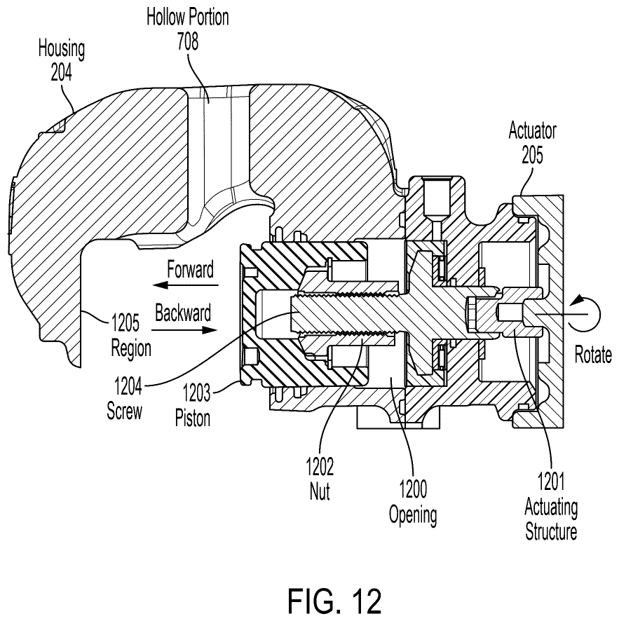

FIG. 8 illustrates a partial cross-sectional view of portions of the parking brake integrated into upright 200 and in relation to parts 600,700 of a vehicle. Parking brake pads 202,203 are mounted on stud 207. The stud may be inserted within connectors 216,217. Stud 207 may have a flange 817 configured to fit flush against connector 216. Each stud 207,208 may include a flange configured to fit flush against a corresponding connector. One end of stud 207 may be inserted within connector 217 and connected 217 may be positioned within groove 220 of the upright. The other end of stud 207 may be within connector 216 and connector 216 may include a grooved and/or apertured portion of the upright. However, each connector of the upright may be a rigid structure coupled to the upright. For example, each connector may be within a groove of the upright or may be an integral grooved apertured portion of the upright. Housing 204 may extend along the length of the stud and include a hollow portion 808 formed therein adjacent the stud and/or one of the parking brake pads. Actuator 205 may include an electrical connection 800 and a motor 801, where each may be in communication (e.g., electrical communication) with the parking brake system 100, for example the parking brake switch 104. As will be described in more detail below with respect to FIGS. 12 and 13, the motor is configured to enable the parking brake pads to be applied to and retracted away from the rotor. Also, the actuator may be coupled to cover 206 and configured to force the parking brake pads against the rotor when the parking brake switch is activated in order to provide braking force(s) to the rotor.

FIG. 9 illustrates a detailed view of parking brake 201 and its components. The parking brake may include housing 204 and parking brake pads 202,203 configured to apply a braking force on a rotor of a vehicle. Additionally, the parking brake may include actuator 205 coupled to the housing. The housing may include a hollow portion 708. However, the housing may be a solid structure without any hollow portions within the housing. The location of the hollow portion in the housing illustrated in FIG. 9 is an example location shown with the illustration. However, the hollow portion may include one or more hollow portions, where the hollow portion(s) may be located on/within the housing at one or more locations such that the hollow portion(s) reduce(s) the mass of the housing, provide(s) structural support for the housing and support(s) forces on the housing. For example, the hollow portion may include a plurality of hollow portions (see FIG. 13) separate/separated from one another or some hollow portions may be connected together (i.e., have a common opening that is fluidly connected) and/or some hollow portions may not be connected together. The parking brake pads 202,203 may be mounted on studs 207,208 and the studs are configured to be coupled to the upright via connectors. Each of the parking brake pads may have a plurality of apertures such that the parking brake pads may be mounted on the studs. The connectors may be integral with the upright or may be rigid structures within a portion of the upright such as grooves or holes within the upright. Fasteners 210,211 may be configured to couple the housing to the upright. For example, each of the fasteners may be positioned such that one end of the fastener has a portion that extends within apertured housing connection 900 of the housing and the one end of each fastener has a flange that seats with (i.e., fits against) a surface of a corresponding housing connection. Each fastener may include threads 212 on another end and the threads may be coupled to corresponding indentations within the upright by the fastener threads 212 mating/coupled with corresponding threads in corresponding indentations and/or providing a friction fit in a portion of the indentation. Threads 212 may be formed on the fasteners or may be threads on an element and the element may be installed on each fastener. The threads of the fasteners and/or the indentations may be formed in a straight line or are curved. The element may include rubber or an elastic material or another material configured to at least provide a coupling such as a friction fit to the indentations of the upright. FIG. 9 illustrates the actuator coupled to the housing however, alternatively and/or in various embodiments, cover 206 may be coupled to the housing where the cover is positioned between the housing and the actuator and the cover is coupled to the housing on one side and is coupled to the actuator on another side. In the alternative and the various embodiments, the upright, the housing and the cover may be made from metal such as an aluminum alloy.

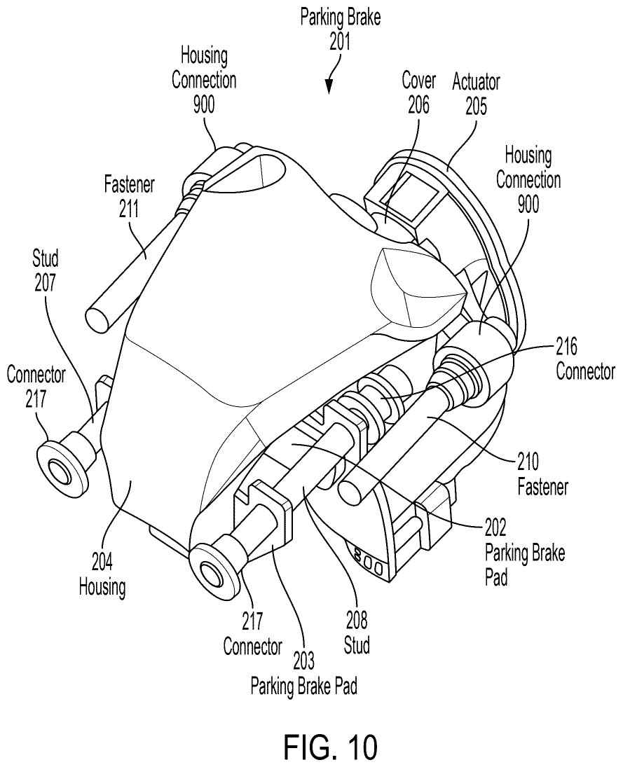

FIG. 10 illustrates another detailed view of parking brake 201 and its components. Some differences between the illustrations in FIGS. 9 and 10 are there are no hollow portions illustrated FIG. 10's housing 204 and FIG. 10 illustrates connectors coupled to the studs and a cover coupled to the housing. The parking brake may include housing 204 and parking brake pads 202,203 configured to apply a braking force on a rotor of a vehicle. Additionally, the parking brake may include cover 206 coupled to the housing and actuator 205 coupled to the cover. The cover may be coupled to the housing and positioned between the housing and the actuator. However, a cover may not need to be part of the parking brake and thus alternatively and/or in various embodiments, a cover is not a feature of the parking brake. For example, the housing may include an integral portion that functions as the cover and the housing may be coupled to the actuator. Thus, alternatively and/or in various embodiments the housing may be a single piece/structure coupled to the upright and the actuator. Also regarding the housing, even though the housing of FIG. 10 does not illustrate a hollow portion, the housing may include one or more hollow portions and the one or more hollow portions may be separate/separated from one another or some hollow portions may be connected together (i.e., have a common opening that is fluidly connected) and/or some hollow portions may not be connected together. Also, the hollow portion(s) may be located on/within the housing at one or more locations such that the hollow portion(s) reduce(s) the mass of the housing, provide(s) structural support for the housing and support(s) forces on the housing. The parking brake pads 202,203 may be mounted on studs 207,208 and the studs are configured to be coupled to connectors 216,217 and to the upright via the connectors. Each of the parking brake pads may have a plurality of apertures such that the parking brake pads may be mounted on the studs. Each of the connectors may be a rigid structure within a portion of the upright such as grooves or holes within the upright. FIG. 10 illustrates the connectors being coupled to the studs however, the connectors may be integral with the upright. The upright, the housing and the cover may be made from metal such as an aluminum alloy. Fasteners 210,211 are configured to couple the housing to the upright. For example, each of the fasteners may be positioned such that one end of the fastener has a portion that extends within apertured housing connection 900 of the housing and the one end of each fastener has a flange that seats with (i.e., fits against) a surface of a corresponding housing connection. Each fastener may include threads 212 on another end and the threads may be coupled to corresponding indentations within the upright by the fastener threads 212 mating/coupled with corresponding threads in corresponding indentations and/or providing a friction fit in a portion of the indentation. Threads 212 may be formed on the fasteners or may be threads on an element and the element may be installed on each fastener. The threads of the fasteners and/or the indentations may be formed in a straight line or are curved. The element may include rubber or an elastic material or another material configured to at least provide a coupling such as a friction fit to the indentations of the upright.

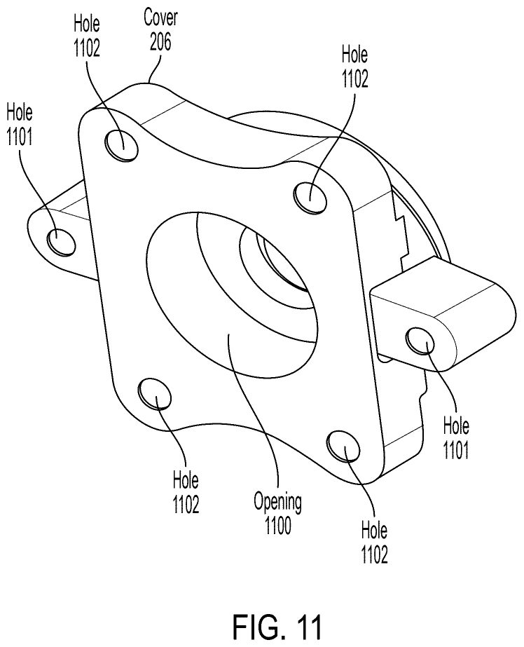

FIG. 11 illustrates a detailed view of cover 206 configured to be coupled to the housing of the parking brake. The cover may include an opening 1100 configured to communicate with (i.e., provides access to) an opening (1200, see FIG. 12) in the housing and configured to allow a portion of the actuator to be therein and/or pass therethrough such that the portion of the actuator is configured to force/apply the one or more parking brake pads against the surface of the rotor and apply a braking force to the rotor. The cover may include holes 1101 to couple/connect the cover to the actuator. For example, fasteners such as screws, rivets or other fastening devices may be inserted into the holes 1101 and couple to corresponding holes or receptacles within the actuator in order to connect the cover to the actuator. Also, the cover may include holes 1102 to allow the cover to be coupled/connected to the housing of the parking brake. For example, fasteners such as screws, rivets or other fastening devices may be inserted into holes 1102 and coupled to corresponding holes or receptacles within the housing in order to connect the cover to the housing.

FIG. 12 illustrates a detailed cross-sectional view of actuator 205 and parking brake housing 204. FIG. 12 illustrates the actuator coupled to the housing. The actuator may include an actuating structure 1201, a nut 1202, a piston 1203 and a screw 1204. The housing may include an opening 1200, a hollow portion 708 and a region 1205 configured to move/force at least one parking brake pad such that the parking brake pad is applied to a surface of the rotor 108 of a vehicle. For example, power is provided, for example from the battery 102 of the parking brake system 100, to the parking brake switch 104 and this power enables activation of the parking brake switch to communicate (e.g., send a signal to an actuator connection) with the electrical connection 800 of the actuator to cause turning/rotation (see rotate arrow) of the actuating structure 1201. The rotation of the actuating structure may cause the screw and the piston to move forward (see forward arrow) if the parking park activation is to apply the one or more parking brake pads to the rotor and may cause the screw and the piston to move backward (see backward arrow) if the parking park activation is to remove/retract/release the one or more parking brake pads from the rotor. The actuator may include a pneumatic actuator. For example, the actuator may include a fluid providing a hydraulic pressure to cause the rotation of the actuating structure forcing the piston to move toward and away from the surface of the rotor. FIG. 13 illustrates more details showing the parking brake pads being applied to the rotor.

FIG. 13 illustrates a detailed perspective cross-sectional view of cover 206 coupled to parking brake housing 204 that is integrated into upright 200, and parking brake pads 202,203 applied to the rotor of a vehicle by components of actuator 205. Housing 204 may include a plurality of hollow portions 708 and a region 1205 configured to move/force parking brake pad 203 such that the parking brake pad is applied to a portion of a surface 1300 of the rotor 108 of a vehicle. FIG. 13 illustrates the housing including four hollow portions. However, the housing may include less or more than four hollow portions. The hollow portion or portions may be located on/within the housing at one or more locations such that the hollow portion(s) reduce(s) the mass of the housing, provide(s) structural support for the housing and support(s) forces on the housing. A difference between the illustrations in FIGS. 12 and 13 is FIG. 13 illustrates the cover is coupled to the housing and the actuator may be coupled to the cover where FIG. 12 illustrates the actuator is coupled to the housing. However, the cover may not need to be part of the parking brake and thus alternatively and/or in various embodiments, a cover is not a feature of the parking brake. For example, the housing may include an integral portion that functions as the cover and the housing may be coupled to the actuator. Thus, alternatively and/or in various embodiments the housing may be a single piece/structure coupled to the actuator and the upright.

Now referring back to FIG. 13, the actuator may include an actuating structure 1201, a nut 1202, a piston 1203 and a screw 1204 configured to move/force the parking brake pads such that the parking brake pads are applied to portions of surfaces 1300,1301 of the rotor of a vehicle. An example operation of the apparatus of FIG. 13 is provided in the below example. For example, power is provided, for example from the battery 102 of the parking brake system 100, to the parking brake switch 104 and this power enables activation of the parking brake switch to communicate (e.g., send a signal to an actuator connection) with the electrical connection of the actuator and cause motor 800 of the actuator to provide rotation (see rotate arrow) of the actuating structure. If the parking brake activation is for the parking brake pads to be applied to the rotor surfaces, the rotation (e.g., in a counterclockwise direction) of the actuating structure causes the screw and the piston to move toward rotor surface 1301 such that the piston forces/applies parking brake pad 202 to a portion of the rotor surface 1301 and causes region 1205 of the housing to move toward rotor surface 1300, by the housing sliding/moving along the length of the fasteners 209,210, to apply parking brake pad 203 to a portion of the rotor surface 1300. If the parking park activation is to remove/retract/release the parking brake pads from the rotor surfaces, the rotation (e.g., in a clockwise direction) of the actuating structure causes the screw and the piston to move away from rotor surface 1301 and causes the housing to slide/move along the length of the fasteners 209,210 such that the parking brake pad 202 is removed from a portion of the rotor surface 1301 and the region 1205 of the housing is moved away from rotor surface 1300 such that parking brake pad 203 is removed from a portion of the rotor surface 1300.

The actuator may be alternatively and/or in various embodiments comprise a pneumatic actuator which includes a fluid causing hydraulic pressure to act upon the piston such that the one or more parking brake pads are applied to one or more surfaces of the rotor. For example, the actuator may include a fluid creating hydraulic pressure that forces the piston to move toward and away from the surface of the rotor.

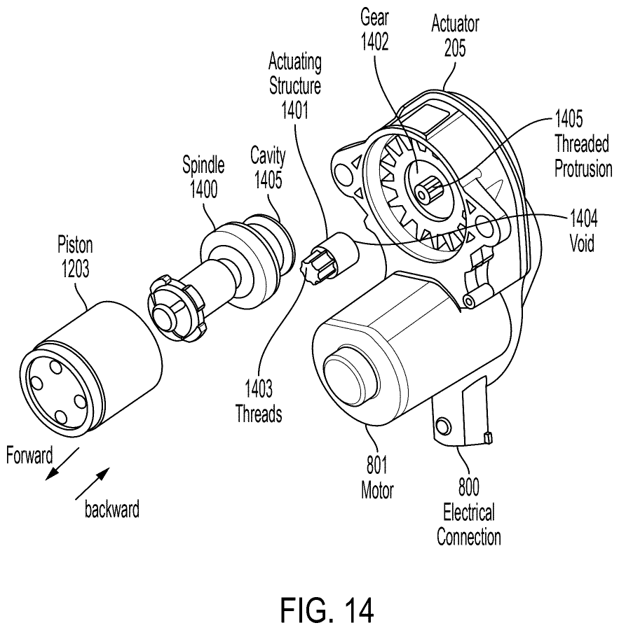

FIG. 14 illustrates a detailed perspective view of an actuator and its components. FIG. 14 illustrates alternative components of actuator 205 from the components illustrated in FIGS. 12 and 13. FIG. 14 illustrates actuator 205 including a piston 1203, a spindle 1400 including a cavity 1405, an actuating structure 1401 including threads 1403 on one end and a void 1404 on another end, a gear 1402 including a threaded protrusion 1405, a motor 801 and an electrical connection 800. The void of the actuating structure is configured to engage with the threaded protrusion of the gear and the threads on the actuating structure are configured to engage with the cavity of the spindle. The cavity may include grooves configured to mate with the threads of the actuating structure. The void may include grooves configured to mate with the threads of the threaded protrusion. The spindle may include a nut and a screw as illustrated in FIGS. 12,13 and thus the spindle may operate as the nut and screw of FIGS. 12,13 to move the piston. When the actuator is engaged (e.g., a signal from the parking brake switch is applied to the electrical connection), the motor may cause the gear to rotate in a direction (e.g., a clockwise direction to move the gear and thus the piston forward or a counterclockwise direction to move the gear and thus the piston backward) and the rotating gear may cause the threaded protrusion to rotate the actuating structure and the rotating actuating structure may cause the spindle to force the piston to move forward (see forward arrow) if the parking brake is to apply the one or more parking brake pads to the surface of the rotor or backward (see backward arrow) if the parking brake is to remove/release the one or more parking brake pads from the surface of the rotor. Any of the disclosed embodiments may employ the actuator with the components disclosed and illustrated in FIGS. 12,13 or FIG. 14.

One or more aspects of the present disclosure may have been described in the context of the related technology. However, none of the aspects described are to be construed as an admission of prior art, unless explicitly stated.

The detailed description set forth above in connection with the appended drawings is intended to provide a description of various example embodiments of the concepts disclosed herein and is not intended to represent the only embodiments in which the disclosure may be practiced. The terms “exemplary” and “example” used in this disclosure mean “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus comprising:
an upright comprising an integral first portion and a second portion, wherein the upright is configured to be coupled to a wheel of a vehicle, and wherein the second portion is configured to integrate a main caliper configured to apply a brake force on a rotor of the vehicle; and
a parking brake comprising one or more parking brake pads, wherein the one or more parking brake pads are mounted to the integral first portion.

2. The apparatus of claim 1, wherein the upright is a three-dimensionally (3D) printed structure.

3. The apparatus of claim 1, wherein the integral first portion comprises a recessed region configured to contain the parking brake.

4. The apparatus of claim 1, wherein the second portion is integral with the upright.

5. The apparatus of claim 4, wherein the second portion comprises a main caliper.

6. The apparatus of claim 1, wherein the parking brake comprises a housing.

7. The apparatus of claim 6, wherein the housing is a three-dimensionally (3D) printed structure.

8. The apparatus of claim 6, wherein the housing is coupled to the integral first portion.

9. The apparatus of claim 6, wherein the housing is configured not to be subjected to a torque generated by at least the one or more parking brake pads applied against the rotor.

10. The apparatus of claim 6, wherein the housing includes a region comprising a hollow portion.

11. The apparatus of claim 10, wherein the region is configured to receive a force generated by at least the one or more parking brake pads applied against the rotor.

12. The apparatus of claim 6, wherein the parking brake comprises a cover coupled to the housing.

13. The apparatus of claim 12, wherein the cover is a three-dimensionally (3D) printed structure.

14. The apparatus of claim 12, wherein the cover comprises a first opening, and wherein the housing comprises a second opening such that a device is configured to extend through the first and second openings and cause the one or more parking brake pads to be applied to the rotor.

15. The apparatus of claim 12, wherein the one or more parking brake pads comprises a first parking brake pad and a second parking brake pad, and wherein the parking brake comprises a structure configured to force the first parking brake pad and the second parking brake pad against the rotor.

16. The apparatus of claim 15, wherein the structure is coupled to the cover.

17. The apparatus of claim 15, wherein the structure comprises an actuator.

18. The apparatus of claim 17, wherein the actuator is configured to be electrically activated.

19. The apparatus of claim 15, further comprising:
a joining device coupled to the integral first portion and to at least the first parking brake pad or the second parking brake pad, wherein a braking force generated by at least the first parking brake pad or the second parking brake pad contacting the rotor is transmitted to the upright.

20. The apparatus of claim 19, wherein the braking force is transmitted to the joining device.

21. The apparatus of claim 20, wherein the braking force comprises a torque.

22. The apparatus of claim 1, wherein the one or more parking brake pads comprises a first parking brake pad and a second parking brake pad, and wherein the first parking brake pad is mounted on a first feature of the integral first portion and the second parking brake pad is mounted on a second feature of the integral first portion.

23. The apparatus of claim 22, wherein the first feature comprises a first structure and a second structure, and wherein the second feature comprises a third structure and a fourth structure.

24. The apparatus of claim 23, wherein the first structure and the second structure are integral with the integral first portion.

25. The apparatus of claim 23, wherein the first structure further comprises a first stud coupled to the first structure and the second structure, and a second stud coupled to the third structure and the fourth structure.

26. The apparatus of claim 22, further comprising:
a joining device coupled to the first feature and the second feature and connecting the first parking brake pad and the second parking brake pad to the integral first portion.

27. The apparatus of claim 26, wherein the first feature comprises a first aperture and a second aperture, and wherein the second feature comprises a third aperture and a fourth aperture.

28. The apparatus of claim 26, wherein the joining device comprises a plurality of connectors.

29. The apparatus of claim 28, further comprising a securing device coupled to at least one of the plurality of connectors and to one of the one or more parking brake pads.
